(19) United States
(12) Patent Application Publication
(10) Pub. No.: US 2021/0349994 A1
(43) Pub. Date: Nov. 11, 2021

(54) ENTERPRISE NOTIFICATION OF TRENDING THREATS

(71) Applicant: International Business Machines Corporation, Armonk, NY (US)

(72) Inventors: PREETI RAVINDRA, Princeton Junction, NJ (US); Ilgen Banu Yuceer, London (GB); Kevin Tabb, Decatur, GA (US)

(21) Appl. No.: 16/871,259

(22) Filed: May 11, 2020

(51) Int. Cl. G06F 21/55; G06Q 50/26; G06Q 50/00; G06Q 30/02; G06Q 10/06; G06F 21/57; G06F 16/9535

(52) U.S. Cl. CPC G06F 21/554; G06Q 50/265; G06Q 50/01; G06Q 30/0201; G06F 2221/034; G06Q 10/06375; G06F 21/577; G06F 16/9535; G06Q 30/0205

(57) ABSTRACT

An approach is provided in which the approach receives a global trending threat corresponding to an incident occurring in an industry. The approach identifies a set of local Indicators of Concern (IoCs) within an entity that corresponds to the global trending threat, and computes an alert priority based on the set of local IoCs and the global trending threat. The approach adjusts the alert priority based on comparing entity properties of the entity with threat properties of the global trending threat, and dispatches an alert based on the adjusted alert priority.

### BACKGROUND

An attack on a computer or a computer network is any attempt to expose, alter, disable, destroy, gain unauthorized access to, or make unauthorized use of, an asset. A cyberattack is any type of offensive maneuver that targets computer information systems, infrastructures, computer networks, or personal computer devices. Cyberattacks may originate from anonymous sources and be employed by sovereign states, individuals, groups, societies, or organizations.

Annual cybercrime cost the global economy hundreds of billions of dollars, which includes gains to criminals as well as costs to companies for recovery and defense. Sophisticated threats and attacks tend to target a certain industry type (e.g., financial industry) or tend to affect areas in a geographic area (e.g., small businesses in Korea). Threat intelligence feeds are available that provide basic threat information to users of current trending threats.

### BRIEF SUMMARY

According to one embodiment of the present disclosure, an approach is provided in which the approach receives a global trending threat corresponding to an incident occurring in an industry. The approach identifies a set of local Indicators of Concern (IoCs) within an entity that corresponds to the global trending threat and computes an alert priority based on the set of local IoCs and the global trending threat. The approach adjusts the alert priority based on comparing entity properties of the entity with threat properties of the global trending threat and dispatches an alert based on the adjusted alert priority.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is an exemplary high level diagram of an enterprise threat notification system altering an enterprise based on analysis of global threats and local threats;

FIG. 4 is a flowchart showing steps taken by an enterprise threat notification cloud service to process local IoCs from SIEM add-on components and alert the SIEM add-on components of possible global trending threats;

FIG. 5 is a flowchart showing steps taken by SIEM add-on components to send local IoCs to an enterprise threat notification cloud service and process global trending threats received from the enterprise threat notification cloud service;

FIG. 6 is a flowchart showing steps taken by SIEM add-on components to adjust security threat alert levels based on comparing entity properties of an entity against threat properties of a global trending threat;

FIG. 7 is a diagram depicting various administrator user interfaces;

FIG. 8 is a diagram depicting a knowledge graph for a single incident investigation.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

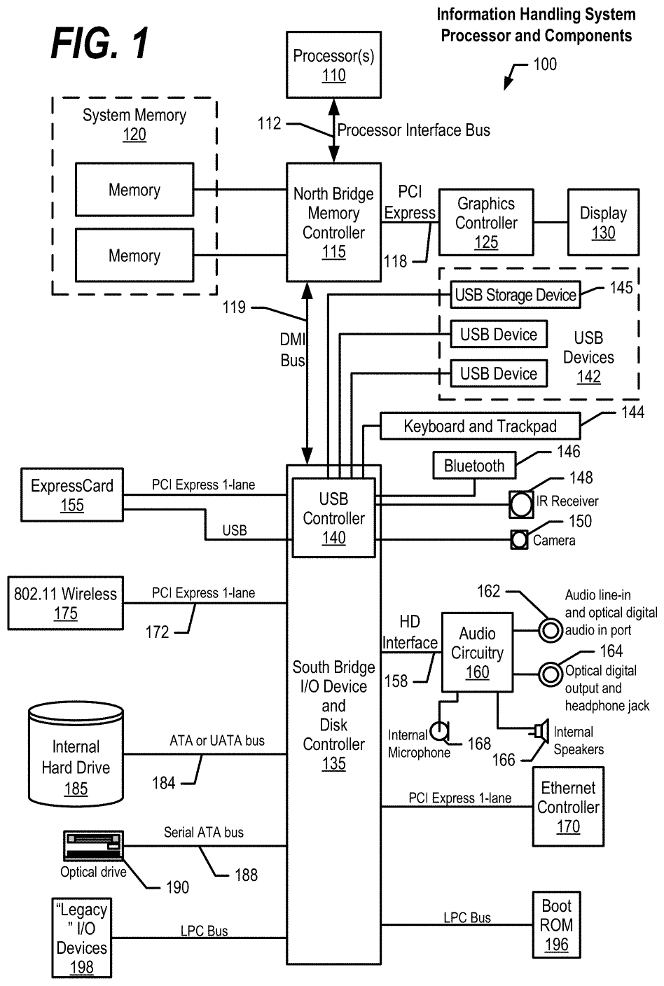

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In some embodiments, the bus is a Direct Media Interface (DMI) bus that transfers data at high speeds in each direction between Northbridge 115 and Southbridge 135. In some embodiments, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wireless communicate between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality associated with audio hardware such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

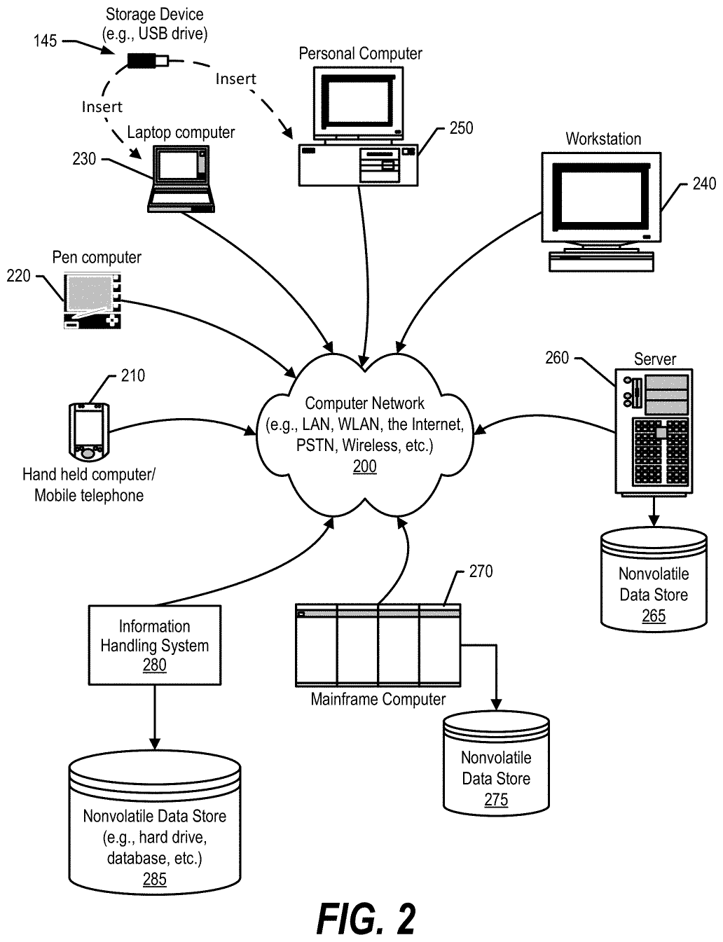

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. The embodiment of the information handling system shown in FIG. 2 includes separate nonvolatile data stores (more specifically, server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

As discussed above, threat intelligence feeds are available that provide basic threat information to users of current trending threats. However, today's threat intelligence feeds do not actively collect trends data from users, but instead, rely on the geographic location and/or industry type information provided by threat intelligence vendors that attempt to select applicable threat intelligence feeds for an organization. In addition, even though threat intelligence feeds are tailored for an enterprise's industry type, most threat intelligence feed providers do not disclose the source of their information to protect their sources and do not incorporate a course of action to take on the trending threats. This lack of information greatly impedes users from understanding the geographic location or industry types that are affected by certain threats and whether the user is likely to face the threats.

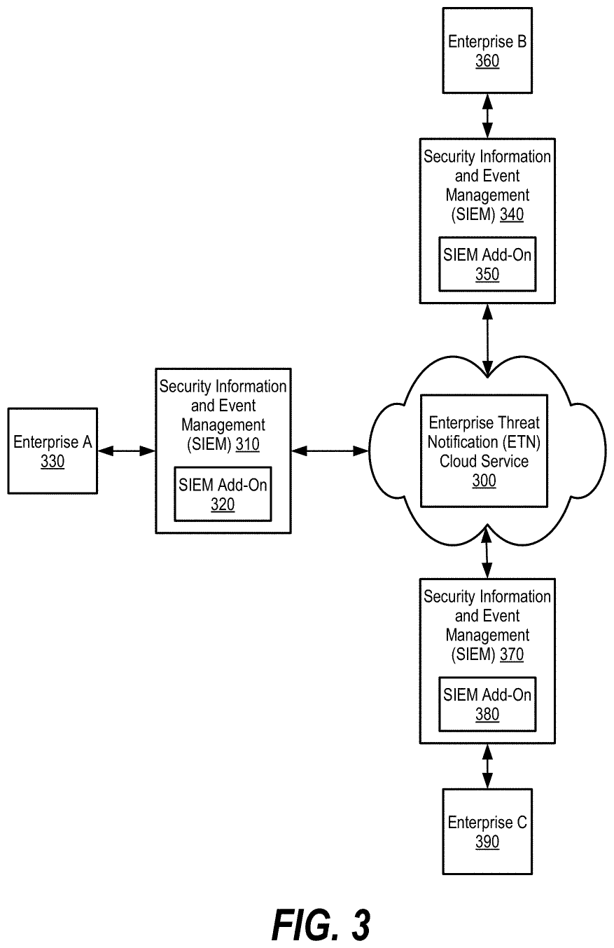

FIGS. 3 through 8 depict an approach that can be executed on an information handling system that proactively identifies and notifies enterprises that are likely targets of global trending threats based on similar industry types and geographic locations. This proactive notification of global trending threats against an enterprise enables the enterprise to take the necessary precautions before the threat targets the enterprise, such as by applying necessary patches and upgrades or disabling vulnerable services that the threat could exploit upon notification.

In one embodiment, the approach combines global trending threats and local Indicators of Compromise (IoC) to further analyze a threat. IoCs are “pieces” of forensic data (e.g., breadcrumbs), such as data found in system log entries or files that identify potentially malicious activity on a system or network. The approach uses global trending threat intelligence feeds to proactively notify enterprises of potential threats that other enterprises within the same industry or within geographic proximity are facing. The approach determines local trends based on the extent of common threats/IoCs that are present in a given user's security environment.

In another embodiment, the approach actively checks for signs of identified potential threats or vulnerabilities to the threats within a user's network and increases or decreases the severity of the notification alert priority accordingly. The approach also identifies potential mitigations or courses of action to address trending threats.

In another embodiment, the approach integrates an add-on component into a Security Information and Event Management (SIEM) system to verify whether an enterprise is actually vulnerable to the threat that the industry or geographic peers are facing. For example, if SIEM analysis yields that a service or vulnerability targeted by a global trending threat is present on the enterprise, then the approach increases the severity of the notification alert priority and generates a critical alert.

In another embodiment, the approach actively builds geographic location/industry type information-based security trends from data collected from all of the system users (crowdsourcing), which the approach then uses to benefit system users by anonymously sharing the information and proactively generating alerts when the users are likely to be affected by the trending threats.

In another embodiment, the approach provides a system for analyzing and identifying global trending threats per industry and geographic location and notifying only those users that are likely to face the global trending threats based on their customer profile (e.g., industry type, geographic location, on-premise equipment, vulnerabilities, etc.). Furthermore, the approach goes beyond passive and generic information that today's threat intelligence feeds provide by 1) actively checking user environments for signs of identified global trending threats; 2) actively checking for vulnerabilities to the threats; and 3) generating alerts and courses of action on trending threats accordingly.

FIG. 3 is an exemplary high-level diagram of an enterprise threat notification system altering an enterprise based on the analysis of global threats and local threats. The enterprise threat notification system includes enterprise threat notification cloud service 300 and Security Information and Event (SIEM) add-on components 320, 350, and 380. The embodiment shown in FIG. 3 shows SIEM add-on components 320, 350, and 380 are integrated into their respective SIEMs 310, 340, and 370. In other embodiments, SIEM add-on components 320, 350, and 380 may be stand-alone entities or may be included in their respective enterprises A 330, B 360, and C 390. As described herein, an “entity” is an enterprise or a combination of an enterprise and a SIEM.

When a SIEM administrator initiates a system startup, the administrator enters customer profile configuration information that includes the company's Standard Industrial Classification (SIC) code, which indicates the company's business type. In addition, the SIEM administrator may provide geographic locations of the company's networks and IT assets or allow the SIEM to automatically determine the geographic locations based on the analysis of the geographic IP resolution services that the system runs on the target network ranges. In turn, SIEM add-on components 320, 350, and 380 send the respective customer profile information to enterprise threat notification cloud service 300.

During operation, SIEM add-on components 320, 350, and 380 analyze security incidents/alerts of their respective enterprise. As part of the analysis, observables such as IP addresses, hashes of suspicious files, domain names and URLs from the logs and network flows that triggered the security incident or alert are identified and investigated, in one embodiment, with the help of threat intelligence feeds.

After the analysis, SIEM add-on components 320, 350, and 380 send the identified observables and indicators of compromise (IoCs) to enterprise threat notification cloud service 300 (e.g., crowdsourcing). As discussed herein, a security event/incident/alert (e.g., malware file “locky”) found by an SIEM add-on component is considered a local indicator of compromise (IoC). When SIEM add-on component finds the same malware file “locky” a statistically significant number times, the SIEM add-on component classifies the grouping as a local trending threat.

Enterprise threat notification cloud service 300 stores the information in a database with geographic locations and industry codes of the enterprises that observed the IoCs. In one embodiment, enterprise threat notification cloud service 300 omits to store information that can be used to identify a specific enterprise to ensure the anonymity of the users of the system. For example, enterprise threat notification cloud service 300 omits to store observables local to the user environment, such as internal IP addresses, URLs, and user names.

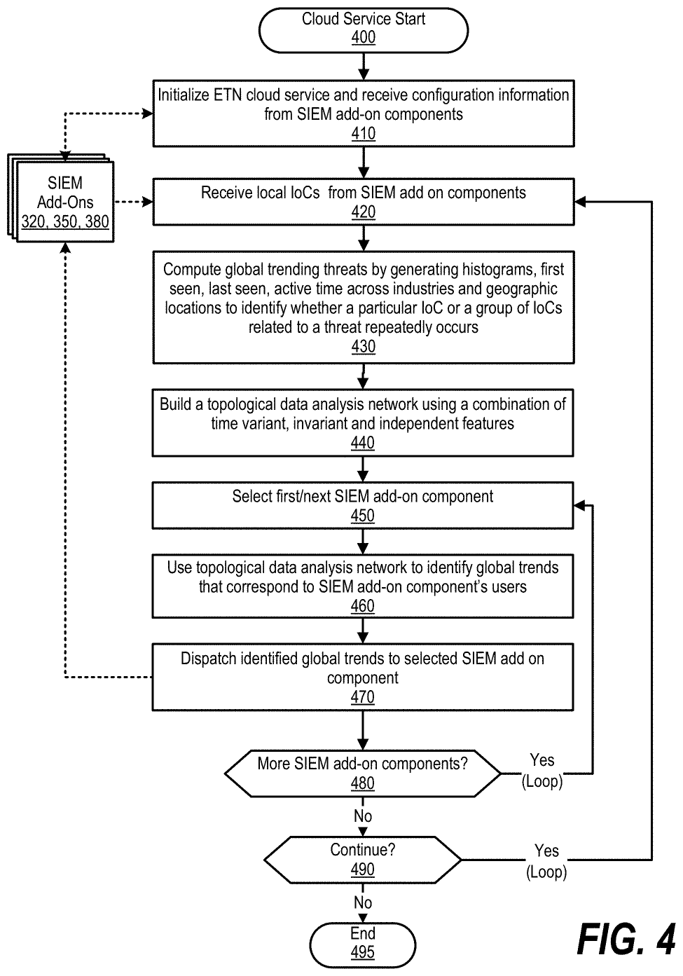

Enterprise threat notification cloud service 300 actively builds geographic location/industry type based security trends from data collected from SIEM add-on components 320, 350, and 380. Enterprise threat notification cloud service 300 then shares pertinent global trending threat information to SIEM add-on components 320, 350, and 380 based on their corresponding customer profiles (see FIG. 4 and corresponding text for further details). SIEM add-on components 320, 350, and 380 evaluate the global trending threats against local trends and entity properties corresponding to their respective enterprise A 330, B 360, and C 390 and proactively generate alerts when their respective enterprises are likely to be affected.

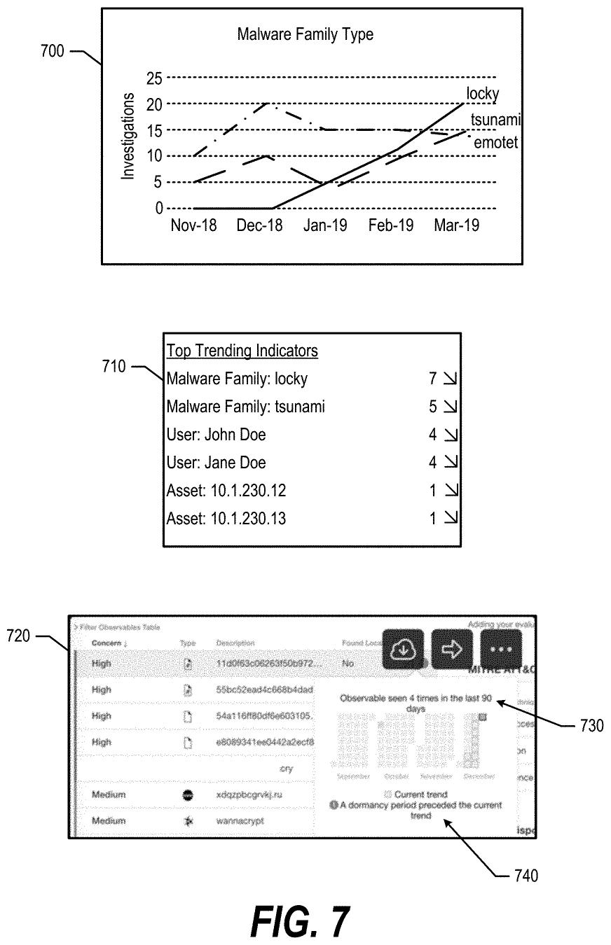

In one embodiment, enterprise threat notification cloud service 300 runs topological data analytics such as generating histograms and computing basic statistics on the collected data to identify whether a particular IoC is repeatedly seen across different users (see FIGS. 4, 7, and corresponding text for further details). Enterprise threat notification cloud service 300 also identifies when a same IoC is first recognized by one of the SIEM add-on components and when the IOC is last recognized to determine when the threat first emerged and how long the threat has been active in particular industries and geographic locations. Enterprise threat notification cloud service 300 correlates industry codes and geographies based on the information collected from users' systems as well as the information present in a security knowledge corpus to determine global trending threats.

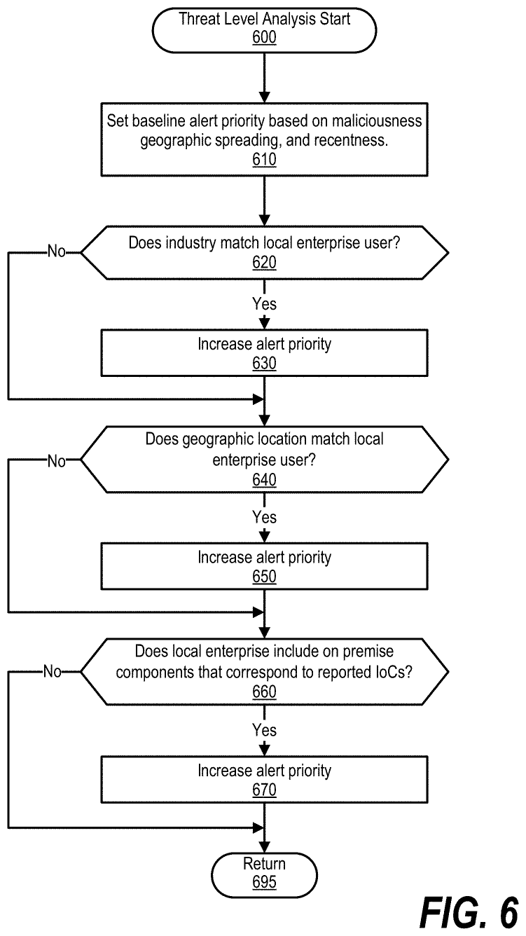

Enterprise threat notification cloud service 300 proactively dispatches alerts to the SIEM add-on components 320, 350, and/or 380 that are likely to be targeted based on their enterprise's corresponding customer profiles. In one embodiment, SIEM add-on components 320, 350, and/or 380 set their own “baseline” alert priority and increase or decrease the trending threat's alert priority based on the maliciousness of the related IoCs, how widespread the trending threat is among the user base, and a time of the trending threat's most recent occurrence (see FIG. 6 and corresponding text for further details).

In another embodiment, SIEM add-on components 320, 350, and/or 380 identify types of assets and services that are present in the user's environment by querying SIEM asset databases as well as running tailored searches on SIEM data that look for any running services that may be targeted. In this embodiment, SIEM add-on components 320, 350, and/or 380 increase the severity of the alert if the types of targets or assets that the threats are known to exploit are present in a user's environment (e.g., the threat may only target Windows 10 systems or Linux systems running a certain service).

In another embodiment, SIEM add-on components 320, 350, and 380 run tailored searches on their respective SIEMs 310, 340, and 370 to identify evidence of reported IoCs within a reported time frame. In this embodiment, the alert includes information on malicious IoCs that are indicators of a trending threat as well as the types of systems and vulnerabilities the trending threat targets, threat actors associated with the trending threat, a time frame of the trending threat (first emerged, last observed), geographic areas, and industries that the trending threat was observed. If a respective SIEM incorporates a vulnerability database, the vulnerabilities that the identified threat is known to exploit are also found in the database by SIEM add-on components 320, 350, and/or 380 and the severity and priority of the alert are increased if the user's systems are found to be vulnerable.

Because not all trends within an organization occur at the same time as other related organizations, SIEM add-on components 320, 350, and 380 convey local trends within their respective organizations. In one embodiment, enterprise threat notification cloud service 300 and/or SIEM add-on components 320, 350, and 380 provide recommended courses of action on trending threats by correlating the trending threats with a security knowledge graph.

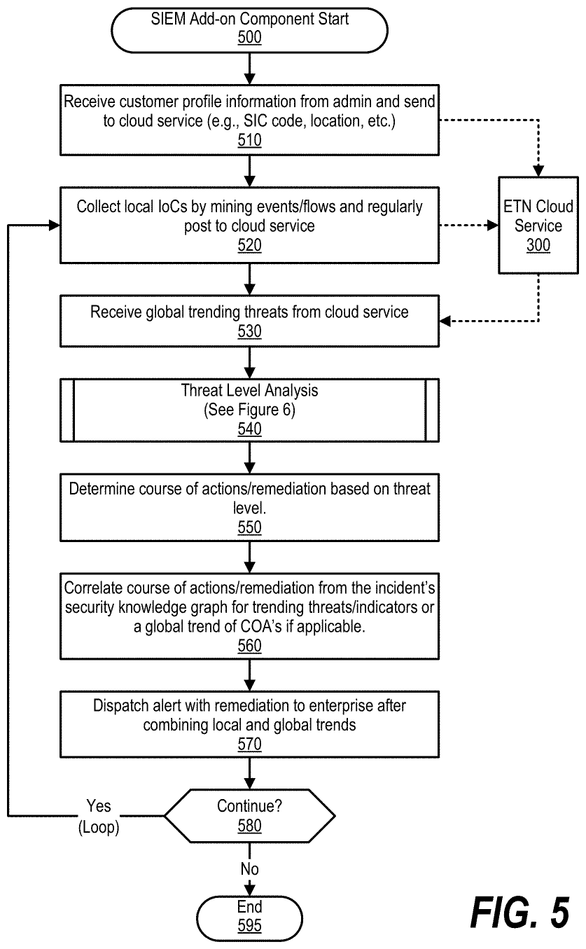

FIG. 4 is a flowchart showing steps taken by enterprise threat notification cloud service 300 to process local IoCs from SIEM add-on components 320, 350, and 380 and alert SIEM add-on components 320, 350, and 380 of possible global trending threats. FIG. 4 processing commences at 400 whereupon, at step 410, the process initializes enterprise threat notification cloud service 300 and receives customer profile configuration information from SIEM add-on components 320, 350, and 380. In one embodiment, the customer profile configuration information includes SIC codes and location information (see FIG. 5 and corresponding text for further details).

At step 420, the process receives IoCs from SIEM add on components 320, 350, and 380 (e.g., crowdsourcing). At step 430, the process computes global trending threats by generating histograms, first seen occurrences, last seen occurrences, active time across industries, and geographic locations to identify whether a particular IoC or a group of IoCs related to a threat repeatedly occurs.

At step 440, the process builds a topological data analysis network using a combination of time-variant, invariant, and independent features based on the received IoCs. In one embodiment, the set of features include:
Time variant: Obs_type, first_seen, last_seen, number_of_offenses;
Time invariant: Investigation/Case characteristics (e.g., Rule names, event categories, log sources, vulnerabilities);
Time independent: cust_geo, cust_industry, assets;
Label: High/Low priority (or Incident disposition); and

In one embodiment, while building the topological data analysis network, the process uses an isolation lens, similarity lens, and clustering to identify anomalous observable traffic and similar user profiles. In this embodiment, the process uses a k-nearest neighbors/agglomerative clustering algorithm to create a network of trending threats in similar user profiles that have anomalous observable traffic to dispatch a threat/anomalous traffic alert.

At step 450, the process selects the first SIEM add-on component (e.g., SIEM add-on 320) and, at step 460, the process uses the topological data analysis network to identify global trending threats that correspond to SIEM add-on component 320's users (e.g., enterprise A 330). At step 470, the process dispatches the identified global trending threats to the selected SIEM add on component (e.g., SIEM add-on component 320).

The process determines as to whether there are more SIEM add-on components to determine whether corresponding global trending threats exist (decision 480). If there are more SIEM add-on components to select, then decision 480 branches to the ‘yes’ branch which loops back to select the next SIEM add-on component and process global trending threats specific to the selected SIEM add-on component. This looping continues until there are no more SIEM add-on components to select, at which point decision 480 branches to the ‘no’ branch exiting the loop.

The process determines as to whether continue (decision 490). If the process should continue, then decision 490 branches to the ‘yes’ branch which loops back to capture more local IoCs from SIEM add-on components 320, 350, and 380. This looping continues until the process should terminate, at which point decision 490 branches to the ‘no’ branch exiting the loop. FIG. 4 processing thereafter ends at 495.

FIG. 5 is a flowchart showing steps taken by SIEM add-on components to send local IoCs to enterprise threat notification cloud service 300 and process global trending threats received from enterprise threat notification cloud service 300. FIG. 5 processing commences at 500 whereupon, at step 510, the process (SIEM add-on components) receives customer profile information from their corresponding SIEM administrator and sends the customer profile information to enterprise threat notification cloud service 300 (e.g., SIC code, geographic location, etc.).

At step 520, the process mines events/flows from their corresponding enterprise to collect local IoCs and regularly post the local IoCs to enterprise threat notification cloud service 300. At step 530, the process receives global trending threats from enterprise threat notification cloud service 300 (see FIG. 4 and corresponding text for further details).

At predefined process 540, the process performs threat level analysis and adjusts alert priorities based on similarities between global trending threats and local characteristics of the SIEM add-on component's corresponding enterprise (see FIG. 6 and corresponding text for processing details).

At step 550, the process determines courses of action/remediation based on the adjusted threat alert priority. At step 560, the process correlates the course of actions/remediation from the incident's security knowledge graph for trending threats/indicators if applicable. At step 570, the process dispatches alerts to an administrator, for example, with remediation to enterprises after combining the local trending threats and global trending threats.

The process determines as to whether to continue (decision 580). If the process should continue, then decision 580 branches to the ‘yes’ branch, which loops back to collect and process more local IoCs. This looping continues until the process should terminate, at which point decision 580 branches to the ‘no’ branch exiting the loop. FIG. 5 processing thereafter ends at 595.

FIG. 6 is a flowchart showing steps taken by SIEM add-on components to adjust security threat alert levels based on comparing entity properties of an entity against threat properties of a global trending threat. FIG. 6 processing commences at 600 whereupon, at step 610, the process sets a baseline alert priority based on the global trending threat's maliciousness, geographic spreading, and recentness.

The process determines as to whether the global trending threat's industry matches the industry corresponding to the local enterprise user (decision 620). If the global trending threat's industry matches the industry corresponding to the local enterprise user, then decision 620 branches to the ‘yes’ branch whereupon the process increases the alert priority at step 630. On the other hand, the global trending threat's industry does not match the industry corresponding to the local enterprise user, then decision 620 branches to the ‘no’ branch bypassing step 630. In one embodiment, the process decreases the alert priority if the global trending threat's industry type does not match the enterprise's industry type.

The process determines as to whether the global trending threat's geographic location matches the geographic location of the local enterprise user (decision 640). If the geographic locations match, then decision 640 branches to the ‘yes’ branch whereupon the process increase the alert priority at step 650. On the other hand, if the geographic locations do not match, then decision 640 branches to the ‘no’ branch. In one embodiment, the process decreases the alert priority if the global trending threat's geographic location does not match the enterprise's geographic location.

The process determines as to whether the local enterprise includes on-premise components that correspond to the reported IoCs, such as similar operating systems, hardware, applications, etc. (decision 660). If the local enterprise includes on premise components that correspond to the reported IoCs, then decision 660 branches to the ‘yes’ branch whereupon the process increases the alert priority at step 670. On the other hand, if the local enterprise does not include on premise components that correspond to the reported IoCs, then decision 660 branches to the ‘no’ branch. In one embodiment, the process decreases the alert priority if the enterprise does not include on premise components corresponding to the reported IoCs. In another embodiment, the process analyzes other entity properties of the local enterprise against threat properties of the global trending threat and adjusts the alert priority accordingly (e.g., vulnerabilities, rules, events, etc.). FIG. 6 processing thereafter returns to the calling routine (see FIG. 5) at 695.

FIG. 7 is a diagram depicting various administrator user interfaces. Diagram 700 shows a graphical representation of various trends of local/global threats that increase/decrease over time. Diagram 710 shows a list of top trending indicators and the most recent amount of new indicators.

Diagram 720 shows the trends for a selected IoC over the last 90 days, for example. In one embodiment, a user may move a mouse pointer over a day in the calendar to show the number of times the IoC was seen that day. The total number of times the IoC was seen over the last 90 days is shown at the top (730). Diagram 720 also shows whether the IoC has re-emerged after being dormant for over 30 days at the bottom “A dormancy period preceded the current trend” (740).

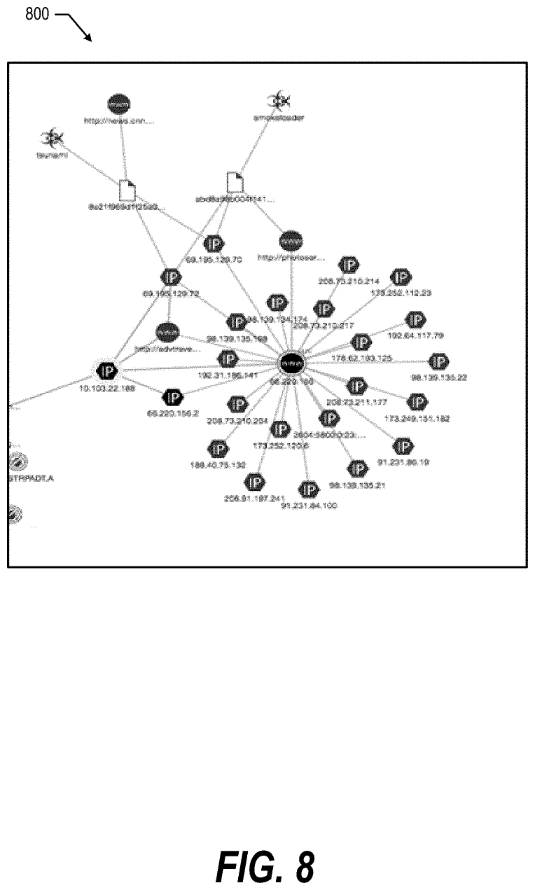

FIG. 8 is a diagram depicting a knowledge graph for a single incident investigation. Diagram 800 shows a visual representation of a security incident and shows all IoCs, assets, servers, and users that were involved in the incident and the relationships between these entities. In one embodiment, an investigation engine generates diagram 800 and graphs investigations over the last 90 days to determine the IoCs and threat trends over time.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
receiving a global trending threat corresponding to an incident occurring in an industry;
identifying a set of local Indicators of Concern (IoCs) within an entity that corresponds to the global trending threat;
computing an alert priority based on the set of local IoCs and the global trending threat;
adjusting the alert priority based on comparing one or more entity properties of the entity with one or more threat properties of the global trending threat; and
dispatching an alert based on the adjusted alert priority.

2. The method of claim 1 wherein, prior to the receiving of the global trending threat, the method further comprises:
crowdsourcing a plurality of IoCs from a plurality of entities, wherein the plurality of IoCs comprise the set of local IoCs and the plurality of entities comprise the entity;
generating a set of features from the crowdsourced plurality of IoCs;
performing a topological data analysis on the set of features;
identifying the global trending threat based on the topological data analysis; and
matching the global trending threat to a customer profile corresponding to the entity.

3. The method of claim 2 wherein at least one of the set of features is selected from a group consisting of a time variant feature, a time invariant feature, a time independent feature, and a label feature.

4. The method of claim 2 wherein the matching indicates one or more vulnerabilities within the entity that is targeted by the global trending threat.

5. The method of claim 1 wherein the adjusting of the alert priority further comprises:
increasing the alert priority in response to determining that the entity is in a geographic location that corresponds to the global trending threat;
determining whether an industry type assigned to the entity corresponds to the global trending threat; and
further increasing the alert priority in response to determining that the industry type assigned to the entity corresponds to the global trending threat.

6. The method of claim 5 further comprising:
determining whether the entity comprises one or more on premise components that correspond to the global trending threat; and
further increasing the alert priority in response to determining that the entity comprises one or more on premise components that correspond to the global trending threat.

7. The method of claim 1 wherein the dispatched alert comprises one or more courses of actions to respond to the global trending threat.

8. An information handling system comprising:
one or more processors;
a memory coupled to at least one of the processors;
a set of computer program instructions stored in the memory and executed by at least one of the processors in order to perform actions of:
receiving a global trending threat corresponding to an incident occurring in an industry;
identifying a set of local Indicators of Concern (IoCs) within an entity that corresponds to the global trending threat;
computing an alert priority based on the set of local IoCs and the global trending threat;
adjusting the alert priority based on comparing one or more entity properties of the entity with one or more threat properties of the global trending threat; and
dispatching an alert based on the adjusted alert priority.

9. The information handling system of claim 8 wherein, prior to the receiving of the global trending threat, the processors perform additional actions comprising:
crowdsourcing a plurality of IoCs from a plurality of entities, wherein the plurality of IoCs comprise the set of local IoCs and the plurality of entities comprise the entity;
generating a set of features from the crowdsourced plurality of IoCs;
performing a topological data analysis on the set of features;
identifying the global trending threat based on the topological data analysis; and
matching the global trending threat to a customer profile corresponding to the entity.

10. The information handling system of claim 9 wherein at least one of the set of features is selected from a group consisting of a time variant feature, a time invariant feature, a time independent feature, and a label feature.

11. The information handling system of claim 9 wherein the matching indicates one or more vulnerabilities within the entity that is targeted by the global trending threat.

12. The information handling system of claim 8 wherein the processors perform additional actions comprising:
increasing the alert priority in response to determining that the entity is in a geographic location that corresponds to the global trending threat;
determining whether an industry type assigned to the entity corresponds to the global trending threat; and
further increasing the alert priority in response to determining that the industry type assigned to the entity corresponds to the global trending threat.

13. The information handling system of claim 12 wherein the processors perform additional actions comprising:
determining whether the entity comprises one or more on premise components that correspond to the global trending threat; and
further increasing the alert priority in response to determining that the entity comprises one or more on premise components that correspond to the global trending threat.

14. The information handling system of claim 8 wherein the dispatched alert comprises one or more courses of actions to respond to the global trending threat.

15. A computer program product stored in a computer readable storage medium, comprising computer program code that, when executed by an information handling system, causes the information handling system to perform actions comprising:
receiving a global trending threat corresponding to an incident occurring in an industry;
identifying a set of local Indicators of Concern (IoCs) within an entity that corresponds to the global trending threat;
computing an alert priority based on the set of local IoCs and the global trending threat;
adjusting the alert priority based on comparing one or more entity properties of the entity with one or more threat properties of the global trending threat; and
dispatching an alert based on the adjusted alert priority.

16. The computer program product of claim 15 wherein, prior to the receiving of the global trending threat, the information handling system performs further actions comprising:
crowdsourcing a plurality of IoCs from a plurality of entities, wherein the plurality of IoCs comprise the set of local IoCs and the plurality of entities comprise the entity;
generating a set of features from the crowdsourced plurality of IoCs;
performing a topological data analysis on the set of features;
identifying the global trending threat based on the topological data analysis; and
matching the global trending threat to a customer profile corresponding to the entity.

17. The computer program product of claim 16 wherein at least one of the set of features is selected from a group consisting of a time variant feature, a time invariant feature, a time independent feature, and a label feature.

18. The computer program product of claim 16 wherein the matching indicates one or more vulnerabilities within the entity that is targeted by the global trending threat.

19. The computer program product of claim 15 wherein the information handling system performs further actions comprising:
increasing the alert priority in response to determining that the entity is in a geographic location that corresponds to the global trending threat;
determining whether an industry type assigned to the entity corresponds to the global trending threat; and
further increasing the alert priority in response to determining that the industry type assigned to the entity corresponds to the global trending threat.

20. The computer program product of claim 19 wherein the information handling system performs further actions comprising:
determining whether the entity comprises one or more on premise components that correspond to the global trending threat; and
further increasing the alert priority in response to determining that the entity comprises one or more on premise components that correspond to the global trending threat.
